(19) United States
(12) Patent Application Publication
(10) Pub. No.: US 2012/0230395 A1
(43) Pub. Date: Sep. 13, 2012

(54) VIDEO DECODER WITH REDUCED DYNAMIC RANGE TRANSFORM WITH QUANTIZATION MATRICIES

(76) Inventors: Louis Joseph Kerofsky, Camas, WA (US); Kiran Misra, Vancouver, WA (US); Christopher Andrew Segall, Camas, WA (US)

(21) Appl. No.: 13/046,514

(22) Filed: Mar. 11, 2011

(51) Int. Cl. H04N 7/26

(52) U.S. Cl. 375/240.03; 375/E07.027

(57) ABSTRACT

A method for decoding video comprising receiving quantized coefficients representative of a block of video representative of a plurality of pixels. The quantized coefficients are dequantized and applying a modification to the dequantized coefficients based upon a quantization matrix. Then inverse transforming the dequanized coefficients to determine a decoded residue.

### CROSS-REFERENCE TO RELATED APPLICATIONS

None.

### BACKGROUND OF THE INVENTION

The present invention relates to image decoding with reduced dynamic range supporting quantization matrices.

Existing video coding standards, such as H.264/AVC, generally provide relatively high coding efficiency at the expense of increased computational complexity. As the computational complexity increases, the encoding and/or decoding speeds tend to decrease. Also, the desire for increased higher fidelity tends to increase over time which tends to require increasingly larger memory requirements and increasingly larger memory bandwidth requirements. The increasing memory requirements and the increasing memory bandwidth requirements tends to result in increasingly more expensive and computationally complex circuitry, especially in the case of embedded systems.

Referring to FIG. 1, many decoders (and encoders) receive (and encoders provide) encoded data for blocks of an image. Typically, the image is divided into blocks and each of the blocks is encoded in some manner, such as using a discrete cosine transform (DCT), and provided to the decoder. The decoder receives the encoded blocks and decodes each of the blocks in some manner, such as using an inverse discrete cosine transform. In many cases, the decoding of the image coefficients of the image block is accomplished by matrix multiplication. The matrix multiplication may be performed for a horizontal direction and the matrix multiplication may be performed for a vertical direction. By way of example, for 8-bit values, the first multiplication can result in 16-bit values, and the second multiplication can result in 24-bit values in some cases. In addition, the encoding of each block of the image is typically quantized, which maps the values of the encoding to a smaller set of quantized coefficients used for transmission. Quantization requires de-quantization by the decoder, which maps the set of quantized coefficients used for transmission to approximate encoding values. The number of desirable bits for de-quantized data is a design parameter. The potential for large values resulting from the matrix multiplication and the de-quantization operation is problematic for resource constrained systems, especially embedded systems.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates an encoder and a decoder.

FIG. 2 illustrates a decoder with a dequantizer and an inverse transform.

FIG. 3A and FIG. 3B illustrates a modified dequantizer.

FIG. 4 illustrates a modified inverse transform.

FIG. 5 illustrates another decoder.

FIG. 6 illustrates yet another decoder.

FIG. 7 illustrates another modified dequantizer.

FIG. 8 illustrates another modified inverse transform.

FIG. 9 illustrates another modified dequantizer.

FIG. 10 illustrates another modified inverse transform.

FIG. 11 illustrates another modified dequantizer.

FIG. 12 illustrates another modified dequantizer.

FIG. 13 illustrates another modified dequantizer.

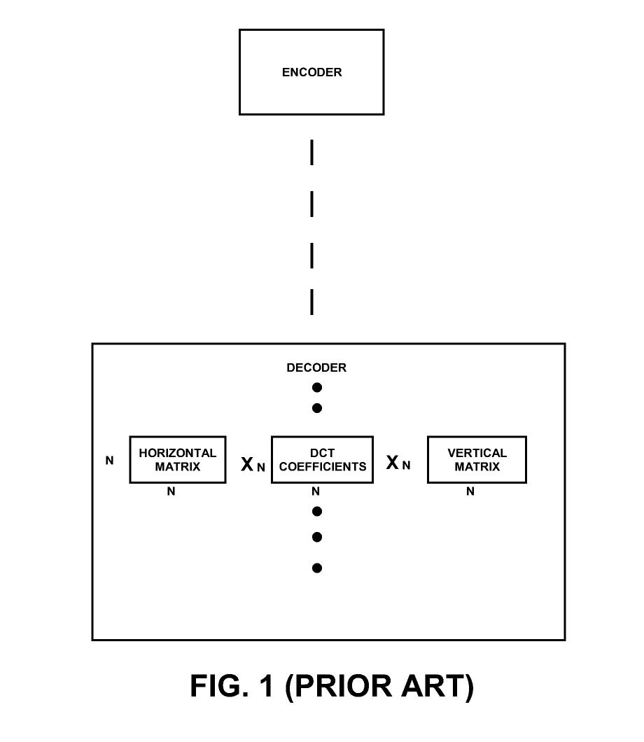

### DETAILED DESCRIPTION OF PREFERRED EMBODIMENT

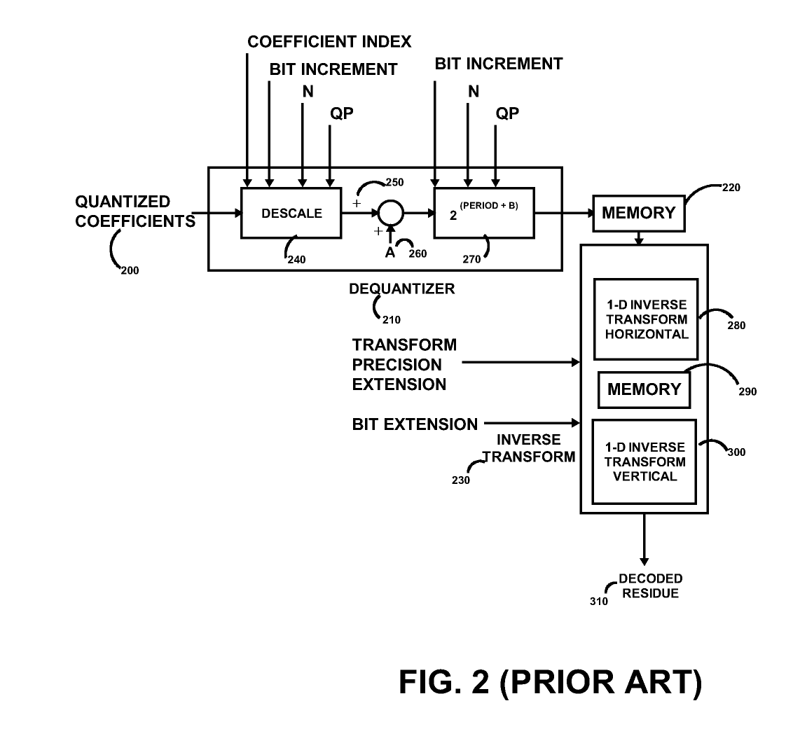

Referring to FIG. 2 (prior art), a decoder for the dequantization and inverse transformation of the received quantized coefficients from the encoder for a block of the image is illustrated, in relevant part. The decoder receives the quantized coefficients 200 at a dequantizer 210. The coefficients resulting from the dequantizer 210 are stored in memory 220. The coefficients stored in memory 220 are then processed by a pair of inverse transforms 230 to determine a decoded residue 310. The inverse transform maps data from a transform domain to a spatial domain using a matrix multiplication operator.

The dequantizer 210 includes the descaling process 240. The descaling process 240 descales the quantized coefficients 200. The descaling process corresponds to multiplying level values (also referred to as quantized coefficients 200) with one integer number dependent on quantization parameter, coefficient index, and transform size (N). An example of the descaling process 240 may include Level*IntegerValue(Remainder,coefficient index)*16 for a dequantizer used prior to an 8×8 inverse transform and Level*IntegerValue (Remainder, coefficient index) for a dequantizer used prior to other transform sizes. The descaling process 240 is preferably based upon a function of a remainder, transform size, and/or a coefficient index (e.g., position), to determine an intermediate set of values 250. The remainder is the sum of the quantization parameter (QP)+P*BitIncrement modulo P ((QP+P*BitIncrement) % P). Modulo as defined in the H.264/AVC standard is defined as: x % y, as remainder of x divided by y, defined only for integers x and y with x>=0 and y>0. In one embodiment P may take on the value 6. An adjustment mechanism A 260 may be applied to the values 250, which may be a variable dependent on transform size and/or a function of a received Period. The period is the sum of the quantization parameter (QP)+P*BitIncrement divided by P ((QP+P*BitIncrement)/P), where “BitIncrement” is the bit depth increment. The “/” as defined in the H.264/AVC standard is defined as: integer division with truncation of the result towards zero. For example, 7/4 and −7/−4 are truncated to 1 and −7/4 and 7/−4 are truncated to −1. In one embodiment P may take on the value 6. The resulting values 250, possibly further modified by mechanism A 260, may be further modified by a factor of 2^{(Period+B)} 270. B is a variable that is dependent on the transform size. The results of the modification 270 are stored in the memory 220. The inverse transformation 230 may perform a 1-dimensional inverse horizontal transform 280, which is stored in memory 290. The inverse transform 230 may also perform a 1-dimensional inverse vertical transform 300, which results in the decoded residue 310. The transforms 280 and 300 may be swapped with each other, as desired.

The memory bandwidth of the video decoder illustrated in FIG. 2, when implemented within the “Part 10: Advanced Video Coding”, ISO publication: ISO/IEC 14496-10:2005—Information Technology —Coding Of Audio-Visual Objects (incorporated by reference herein) (H.264/AVC standard), may be limited by using a constraint. For example, in section 8.5.10 of the H.264/AVC standard, the width of the memory access for 4×4 luma DC transform coefficients is limited by including the following statements: “The bitstream shall not contain data that result in any element fᵢⱼ of f with i, j=0.3 that exceeds the range of integer values from −2^{(7+bitDepth)} to 2^{(7+bitDepth)}−1, inclusive.” and “The bitstream shall not contain data that result in any element dcYᵢⱼ of dcY with i, j=0.3 that exceeds the range of integer values from −2^{(7+bitDepth)} to 2^{(7+bitDepth)}−1, inclusive.” The H.264/AVC standard includes similar memory limitation for other residual blocks. In addition to including a complex memory bandwidth limitation, the H.264/AVC standard includes no mechanism to ensure that this limitation is enforced. Similarly, the JCT-VC, “Draft Test Model Under Consideration”, JCTVC-A205, JCT-VC Meeting, Dresden, April 2010 (JCT-VC), incorporated by reference herein, likewise does not include a memory bandwidth enforcement mechanism. For robustness, a decoder must be prepared to accept bitstreams which may violate these limits may be caused by transmission errors damaging a compliant bitstream or a non-conforming encoder. To alleviate such potential limitations the decoder frequently includes additional memory bandwidth, at added expense and complexity, to accommodate the non-compliant bit streams that are provided.

In order to provide a more computationally robust decoder with limited memory bandwidth and/or memory storage requirements, the decoder should be modified in a suitable manner. However, while modifying the decoder to reduce the memory requirements, the corresponding rate distortion performance of the video should not be substantially degraded. Otherwise, while the memory requirements may be reduced, the resulting quality of the video will not be suitable for viewing by the audience. The modification 270 results in changing the coefficient value based upon changes in the steps in the quantization parameter P, and thus may substantially increase the size of the memory requirements. For example, the coefficients double for every 6 steps in the quantization parameter P. The increased value results in one or more zeros being included as the least significant bits. Preferably, the decoder is modified in a suitable manner to effectuate an enforcement mechanism for the memory bandwidth.

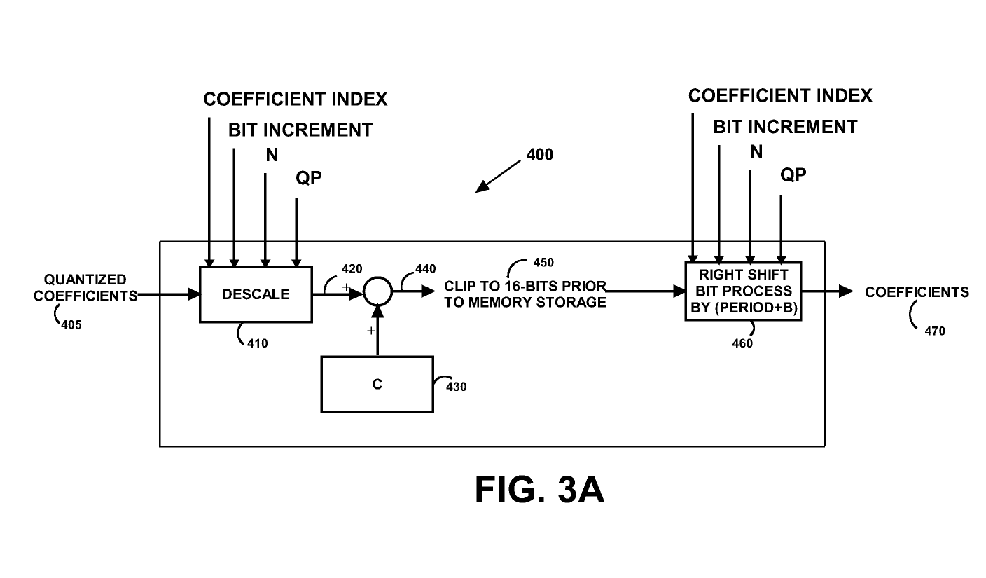

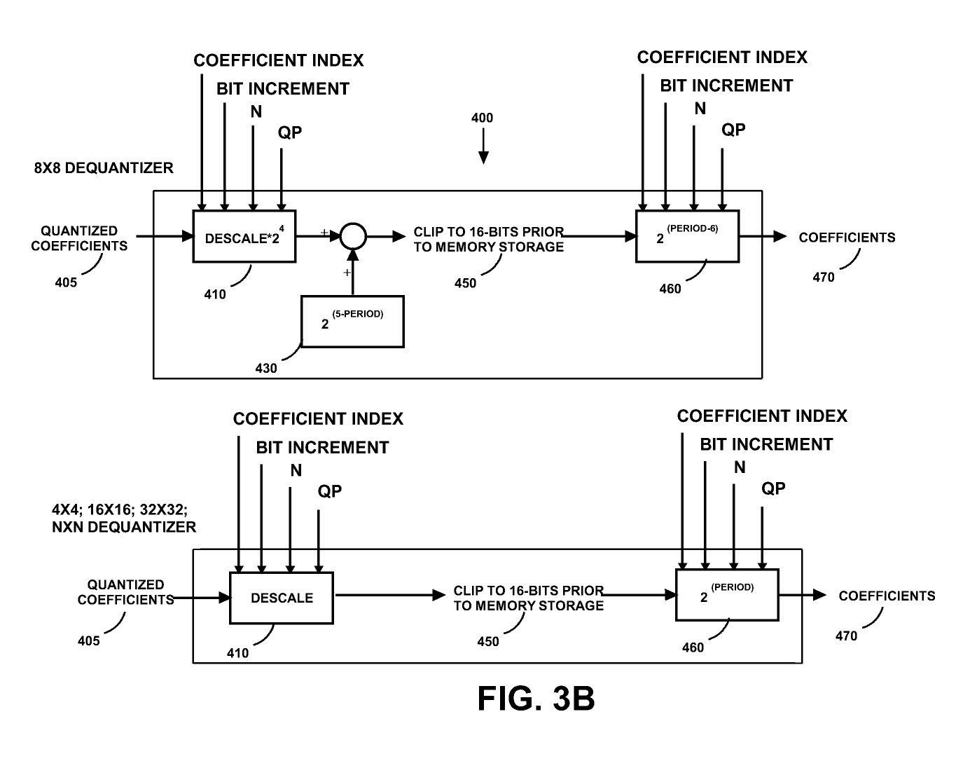

Referring to FIG. 3A, with this understanding of the operation of the dequantizer 210 (see FIG. 2, prior art) an improved dequantizer 400 (see FIGS. 3A and 3B) receives the quantized coefficients 405 and descales 410 the quantized coefficients, preferably based upon a function of a remainder, transform size, and/or a coefficient index (e.g., position), to determine an intermediate set of values 420. The quantization parameter may be in the form of a matrix of values dependent on frequency. Typically, the position of a value in the quantization matrix relates to its frequency (e.g., spatial frequency) and thus the quantizer can be non-constant for each block or group of pixels. In general, the quantization parameters may change in any suitable manner, such as each frame, each block, each set of blocks, or otherwise as desired. An optional adjustment mechanism using a variable C 430 may be applied, which is preferably a variable dependent on transform size (N) and/or a function of one or more received quantization parameters (QP), to determine resulting data 440. The resulting data 440 from the quantized coefficients 405 may include rogue data or otherwise is not compliant with a standard, and accordingly the dequantizer 400 may impose a fixed limit on the resulting data 440. The resulting data 440 is may be clipped 450 to a predetermined bit depth, and thus an N×N block of data is stored in memory within the dequantizer 400. For example the clipping 450 for a predetermined bit depth of 16 bits results in any values over 32,767 being set to the maximum value, namely, 32,767. Likewise for a predetermined bit depth of 16 bits results in any values less than −32,768 being set to the minimum value, namely, −32,768. Other bit depths and clipping values may likewise be used. In this manner, the maximum memory bandwidth required is limited by the system, in a manner independent of the input quantized coefficients. This reduces the computational complexity of the system and reduces the memory requirements, which is especially suitable for embedded systems.

After imposing the clipping 450, the data with the maximum predetermined bit depth is modified by a factor of 2^{(Period+B)} 460. The results of the modification 460 are provided as coefficients 470. The result of performing the 2^{(Period+B)} 460 after the clipping 450 reduces the rate distortion loss. Preferably, the adjustment mechanism 430 used for 8×8 transform coefficients is 2^{(5-Period)} and the 2^{(Period+B)} 460 is 2^{(Period-6)}. The process 460 may be based upon, if desired, a function of the transform size (N) or a function of a received quantization parameter (QP). Also, the adjustment mechanism 430 used for other sized transform coefficients (such as 4×4, 16×16, and 32×32) has the variable B preferably set to zero, and therefore the value of 2^{(Period+B)} 460 is 2^{(Period)}. The result of the expression 2^{(Period+B)} may be implemented as a right shift bit process by (Period+B) as shown in the modification 460. Further, the 2^{(5-Period)}, 2^{(Period+B)}, and the 2^{(Period-6)} expressions may be implemented as shift processes Also, B may be a function of N and C may be a function of N. Referring to FIG. 3B, a particular implementation of FIG. 3A is illustrated.

Referring to FIG. 3B, the 8×8 dequantizer may be characterized as follows.

Int iAdd=(1<<5)>>Period

where << is a left bit shift, >> is a right bit shift, Int is an integer operation, and iAdd is a variable.

Without clipping:

dstCoef=((iLevel*iDeScale*16+iAdd)<<Period)>>6

With clipping:

dstCoef=(CLIP_TO_{—}16BITS(iLevel*iDeScale*16+iAdd)<<Period)>>6

Referring to FIG. 3B, the 4×4, 16×16, 32×32; and N×N may be characterized as follows.

Without clipping:

dstCoef=(iLevel*iDeScale)<<Period

With clipping:

dstCoef=CLIP_TO_{—}16BITS(iLevel*iDeScale)<<Period

In either case, the scaling of 2^{Period+B} in FIG. 3A or the scaling of 2^{Period-6} in FIG. 3B is executed before the inverse transform is performed thus resulting in the first stage of the inverse transform being dependent on the transform period QP. The dependency on QP of the embodiments of FIG. 3A and FIG. 3B after the memory storage, increases the computational complexity of the system, which could be reduced if such dependency on QP was reduced.

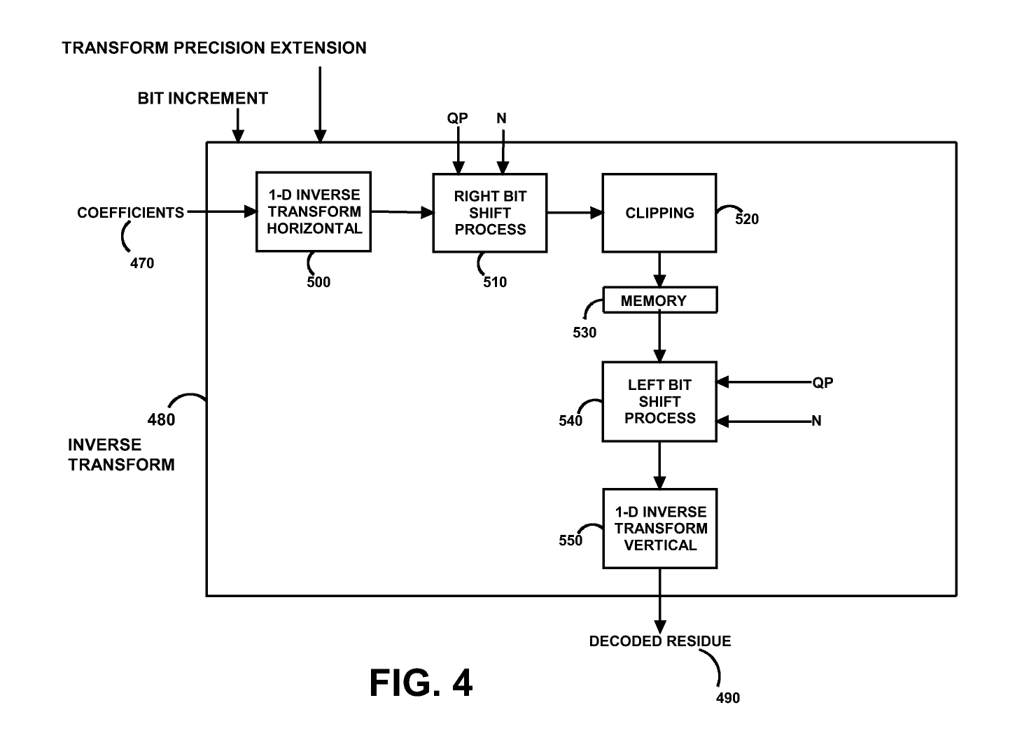

Referring to FIG. 4, the coefficients 470 from the dequantizer 400 (see FIGS. 3A and 3B) are provided to an inverse transform 480 designed to provide a decoded residue 490 that has an acceptable rate distortion loss. The coefficients 470 are preferably transformed by a 1-dimensional inverse horizontal (or vertical) transform 500. Based upon a desirable number of output bits to maintain an acceptable rate distortion loss, the output of the transform 500 may be modified by a right bit shift process 510 for a desirable number of bits. In this manner, a selected number of the least significant bits are discarded in order to reduce the memory requirements of the system. For example, if 19 bits are likely to result from the inverse transform 500 and it is desirable to have a 16 bit outcome, then the right bit shift process 510 removes the 3 least significant bits. The resulting shifted bits are clipped 520 to a predetermined threshold. An example of a predetermined threshold may be 16-bits. The clipping 520 further enforces a memory bandwidth limitation, the results of which are stored in memory 530. The data stored in memory 530 is substantially reduced as a result of the shifting 510 removing the least significant bit(s). The data stored in the memory 530 is then shifted left by a left bit shift process 540, preferably by the same number of bits as the right bit shift process 510. The shifting results in zeros in the least significant bit(s). The shifted data is then preferably transformed by a 1-dimensional inverse vertical (or horizontal) transform 550, resulting in the decoded residue 490.

The rate distortion loss is dependent on the number of bits used in the processing and the data block size. Preferably, the right bit shift process 510 and the left bit shift process 540 are dependent on the size N of the block (number of horizontal pixels×number of vertical pixels for a square block of pixels). For example, for a 4×4 block the shift may be 3, for an 8×8 block the shift may be 2, for a 16×16 block the shift may be 8, and for a 32×32 block the shift may be 9. Alternatively, the right bit shift process 510 and the left bit shift process 540 may be determined based upon a parameter, such as a quantization parameter (QP), passed in the bit stream, internal bit-depth increment (IBDI), the transform precision extension (TPE) parameters, or otherwise selectable by the decoder.

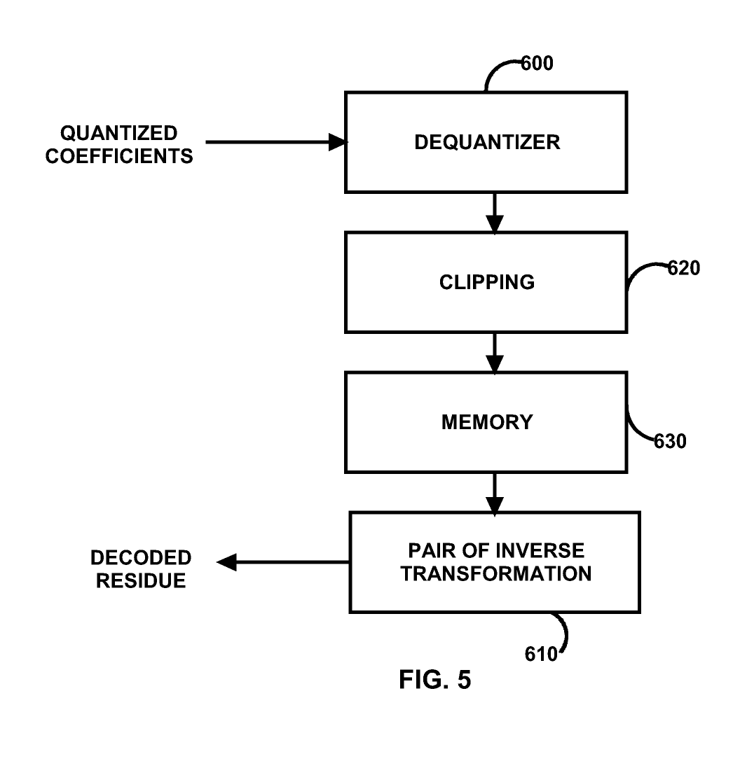

Referring to FIG. 5, in another embodiment the decoder receives the quantized coefficients which are processed by any suitable dequantizer 600 and any suitable inverse transform 610. It is desirable to include an express memory bandwidth limitation which is preferably implemented by including a clipping function 620. After the clipping function 620, the data may be stored in memory 630, which is thereafter used for the inverse transform 610.

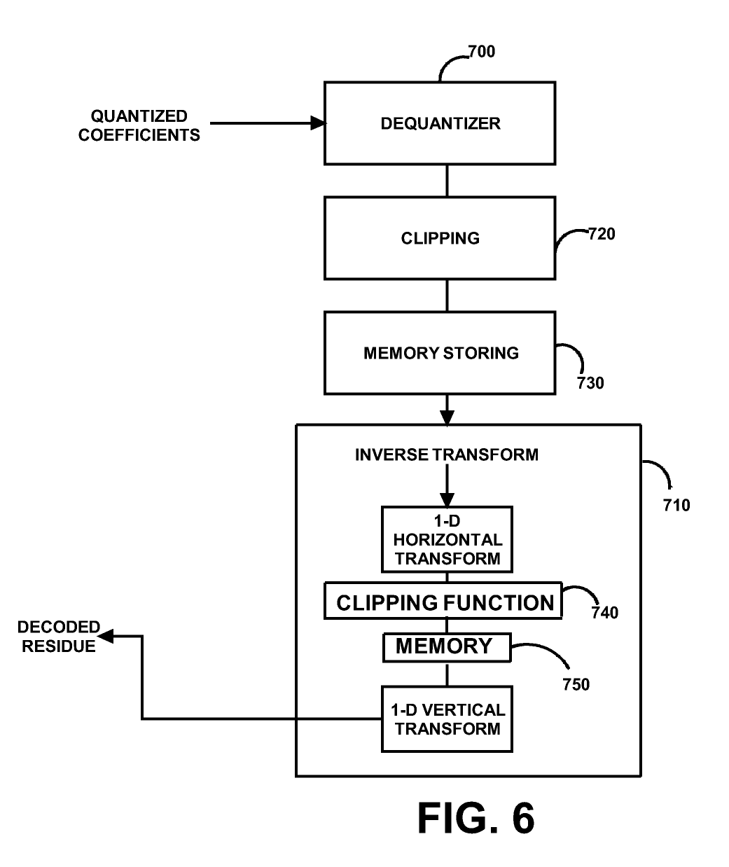

Referring to FIG. 6, in another embodiment the decoder receives the quantized coefficients which are processed by any suitable dequantizer 700 and any suitable inverse transform 710. For example, the inverse transform may be the one illustrated in FIG. 4. It is desirable to include an express memory bandwidth limitation to reduce the computation complexity which is preferably implemented by including a clipping function 720. After the clipping function 720, the data may be stored in memory 730, which is thereafter used for the inverse transform 710. It is further desirable to include an explicit memory bandwidth limitation which is preferably implemented by including a clipping function 740 between a pair of 1-dimensional transforms. The 1-dimensional transforms may be performed in any order or manner. After the clipping function 740, the data may be stored in memory 750.

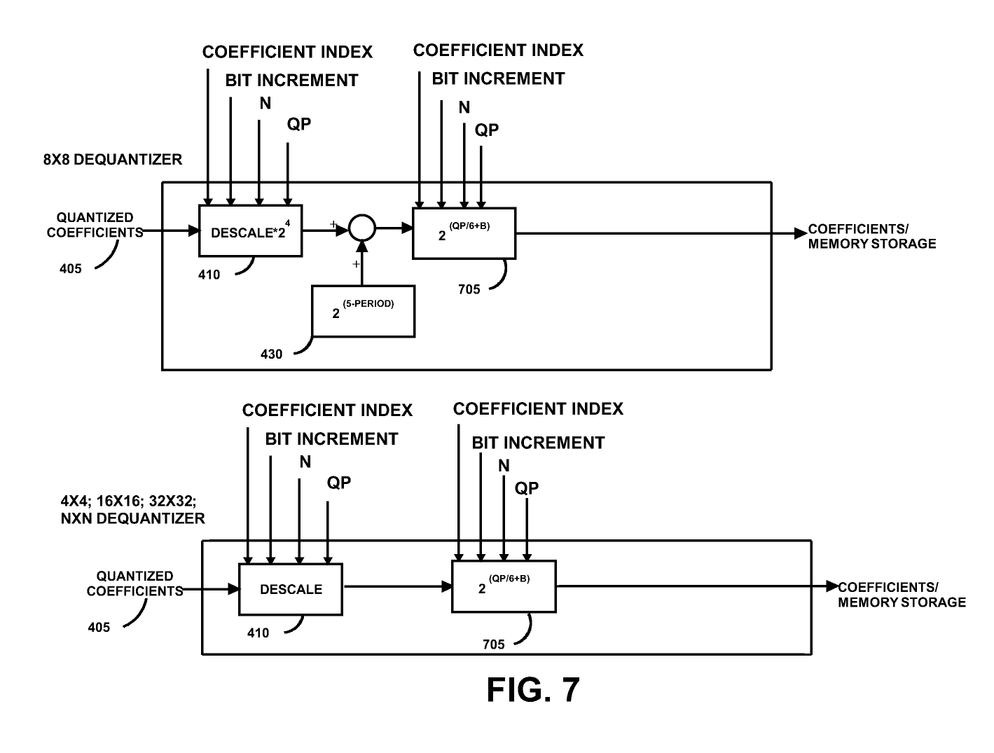

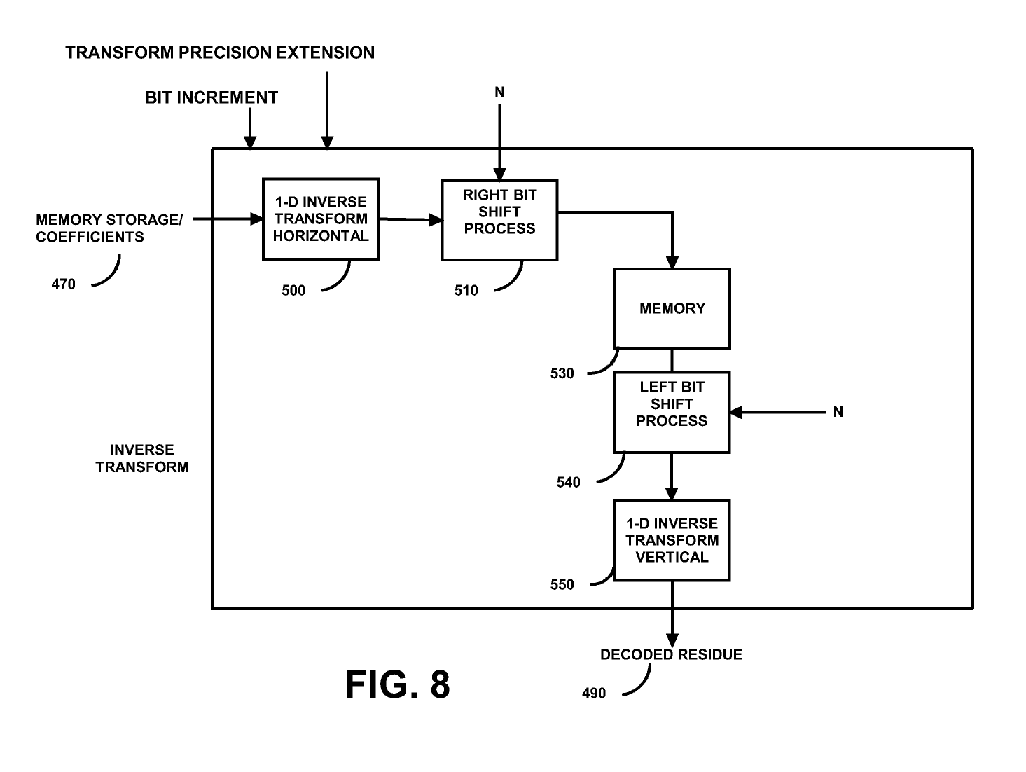

Referring to FIG. 7, to reduce the dependency on QP, an embodiment may include the modification 460 (see FIGS. 3A and 3B) being performed prior to storing the resulting coefficients in memory, by a shifting operation 705 such as 2^{(QP/6+B)}. Similar to FIG. 3A and FIG. 3B, the quantized coefficients 405 may be descaled 410, and optionally modified by the adjustment mechanism 430. In this manner, the quantization parameters do not need to be stored together with the coefficients in memory, since the further inverse transform may be performed in a manner independent of the quantization parameters, as illustrated in FIG. 8.

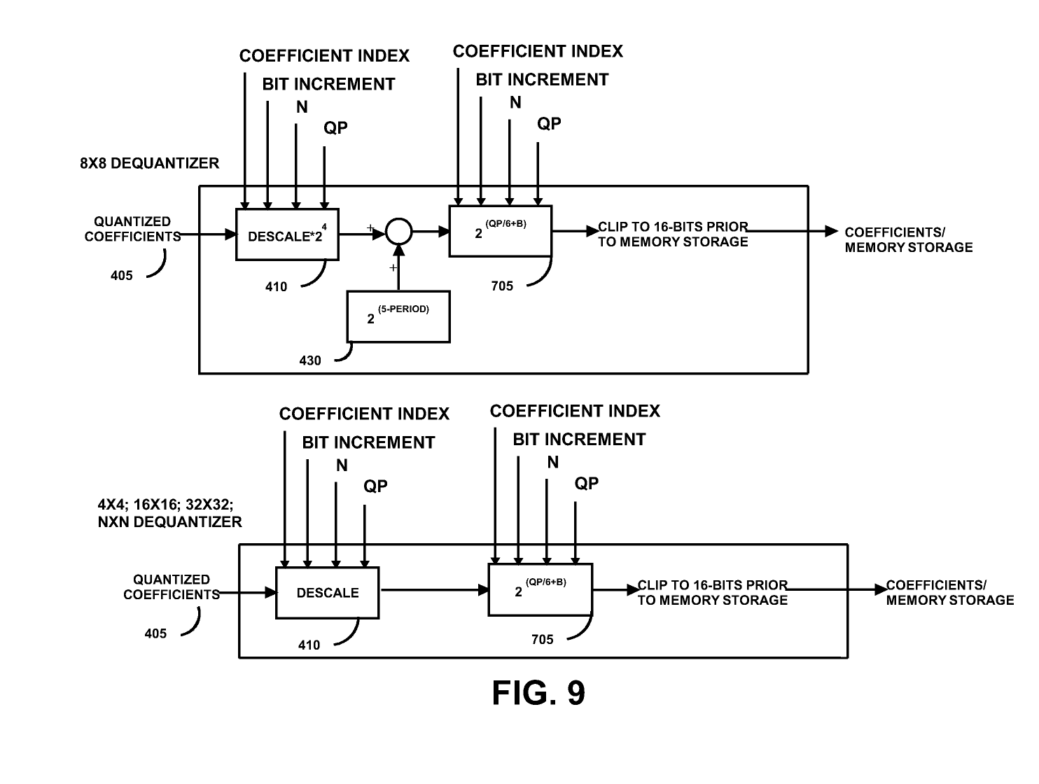

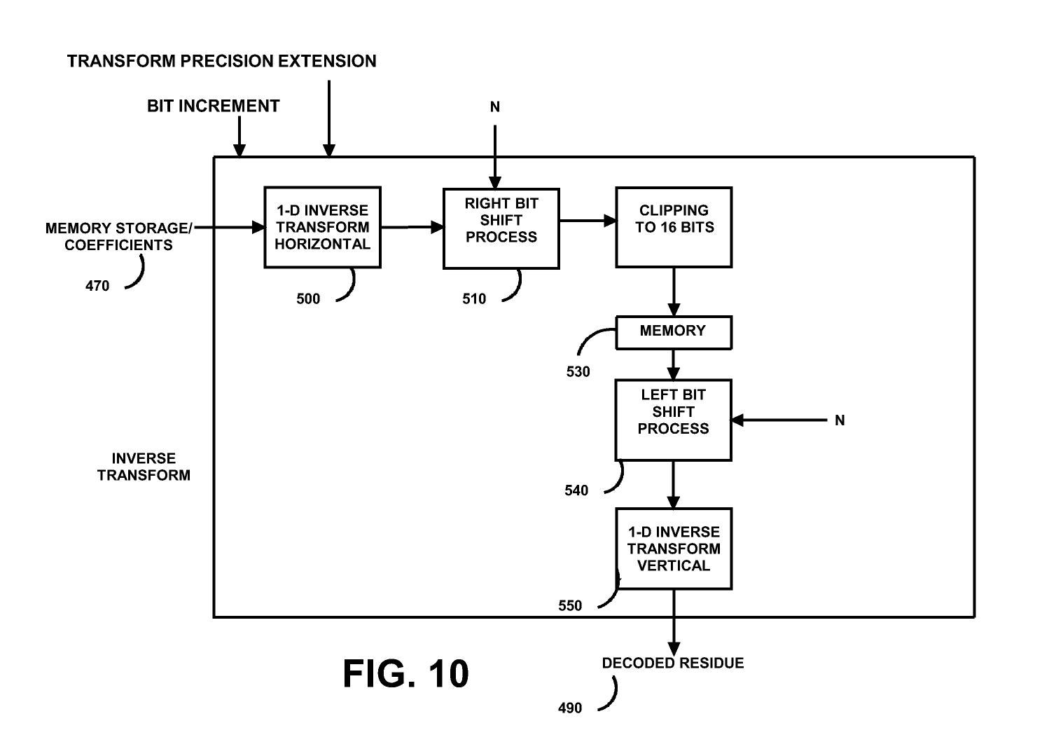

Referring to FIG. 9, a further technique includes clipping the number of bits at the memory storage to a suitable number, such as 16 bits. Referring to FIG. 10, a further technique includes clipping the number of bits at the memory storage to a suitable number, such as 16 bits. While such an approach decreases the computational complexity of the system, the resulting video tends to have degraded video quality.

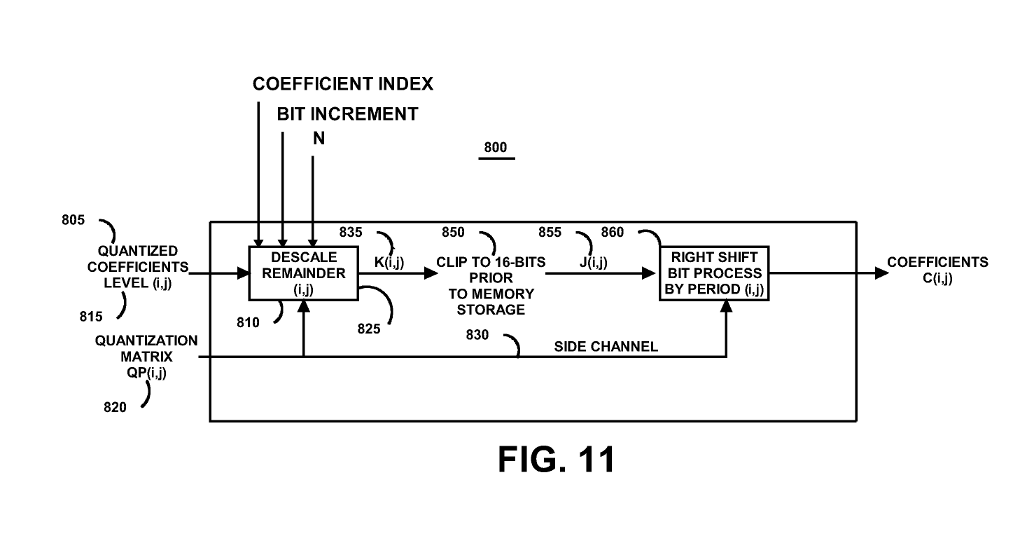

Referring to FIG. 11, a modified dequantizer 800 is especially suitable for descaling with a frequency dependent quantization matrix that include a quantization matrix QP(i,j) 820. The quantized coefficients 805 are referred to as Level(i,j) 815. The descaling 810 may be based upon a remainder(i,j) 825 that is characterized as Remainer(i,j)=(QP(i,j)+P*BitIncrement) % P, where P is preferably 6. An intermediate K(i,j) 835 may be characterized as K(i,j)=A(Remainder(i,j))*Level(i,j) where the descale process 810 multiplies by a value A(Remainder(i,j)) which depends on the term Remainder(i,j). The clipping 850 may be characterized as Clip K(i,j) to 16-bits. An intermediate J(i,j) 855 may be characterized as J(i,j)=Clip(K(i,j),16). The shifting process 860 2^{Period(ij)} may be characterized as C(i,j)=J(i,j)<<(Period(i,j)), where Period(i,j)=(QP(i,j)+P*BitIncremenet)/P. Preferably the process is integer division and P is 6. Accordingly, the quantization matrix QP 820 is provided to the descaling process 800 and the shifting process 860, which is a process subsequent to the clipping and memory storage 850. Providing the quantization matrix QP 820 to the shifting process 860 is typically provided through a “side channel” process 830. In this manner, the shifting of the coefficients is by the corresponding values in the quantization matrix.

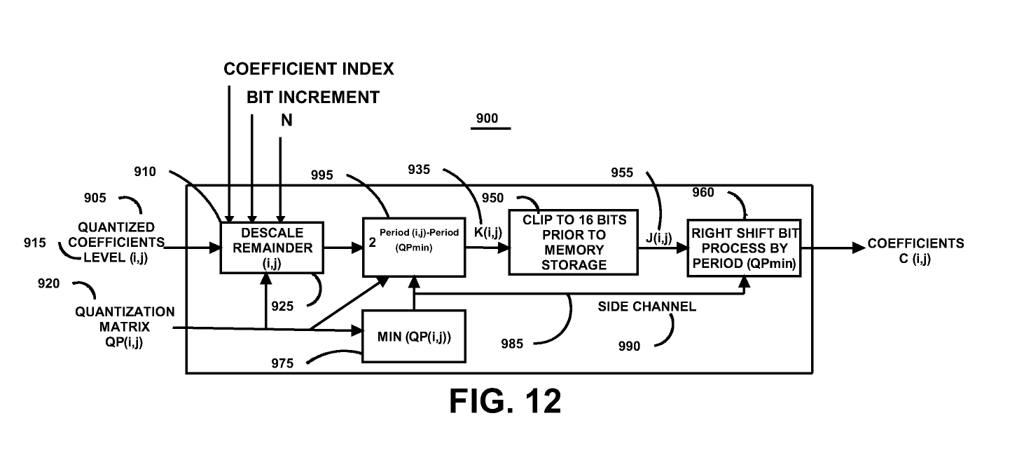

To further reduce the computational complexity of the system, it is desirable that the entire quantization matrix, which can be significant in some embodiments, does not need to be provided to the shifting process. Referring to FIG. 12, a modified descaling technique 900 with a frequency dependent quantization matrix includes a quantization matrix QP(i,j) 920. The quantized coefficients 905 are referred to as Level(i,j) 915. The descaling 910 may be based upon a remainder(i,j) 925 that is characterized as Remainer(i,j)=(QP(i,j)+P*BitIncrement) % P, where P is preferably 6. An intermediate K(i,j) 935 may be characterized as K(i,j)=A(Remainder(i,j))*Level(i,j)<<(Period(i,j)-Period(QPmin)) where QPmin is the minimum of the set of values QP(i,j) in the quantization matrix. The clipping 950 may be characterized as Clip K(i,j) to 16-bits. An intermediate J(i,j) 955 may be characterized as J(i,j)=Clip(K(i,j),16). The shifting process 960 2^{Period(QPmin)} may be characterized as C(i,j)=J(i,j)<<Period(QPmin), where Period(QPmin)=(QPmin+P*BitIncrement)/P, where P is preferably 6. Accordingly, the quantization matrix QP is provided to the descaling process and the initial shifting process, which is a process prior to the clipping and memory storage. A minimum quantization function 975 determines the minimum quantization value for the matrix. This minimum quantization value 985 is provided to the shifting processes 995. In this manner, only a single value, namely the minimum quantization value or Period(QPmin), is provided typically through a “side channel” process 990. In this manner, the shifting of the coefficients is by the corresponding values in the quantization matrix, but only a limited amount of data needs to be provided in addition to that stored in memory. In general, the minimum quantization value may be any set of data less than the entire quantization matrix.

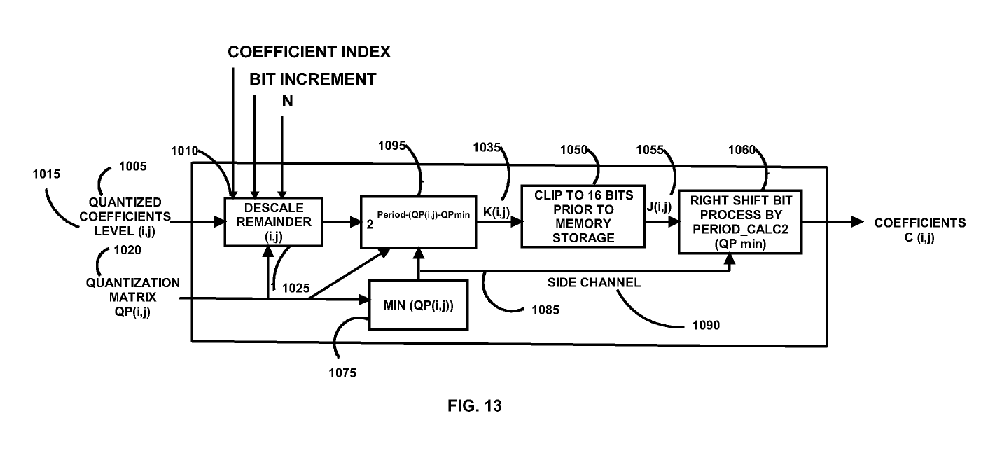

Referring to FIG. 13, a modified descaling technique 1000 with a frequency dependent quantization matrix includes a quantization matrix QP(i,j) 1020. The quantized coefficients 1005 are referred to as Level(i,j) 1015. The descaling 1010 may be based upon a remainder(i,j) 1025 that is characterized as Remainer(i,j)=(QP(i,j)+P*BitIncrement) % P, where P is preferably 6. An intermediate K(i,j) 1035 may be characterized as K(i,j)=A(Remainder(i,j))*Level(i,j)<<PERIOD_CALC1(QP(i,j)−QPmin), where PERIOD_CALC1(x)=floor[x/6]. The clipping 1050 may be characterized as Clip K(i,j) to 16-bits. An intermediate J(i,j) 1055 may be characterized as J(i,j)=Clip(K(i,j),16). The shifting process 1060 2^{PERIOD}^{_{—}}^{CALC2(QPmin)} may be characterized as C(i,j)=J(i,j)<<PERIOD_CALC2(QPmin), where PERIOD_CALC2(x)=ceil[x+6*BitIncrement)/P], where P is preferably 6. The flooring and ceiling functions are preferably floating point operations. Accordingly, the quantization matrix QP is provided to the descaling process and the initial shifting process, which is a process prior to the clipping and memory storage. A minimum quantization function 1075 determines a minimum quantization value for the matrix, such as using flooring and ceiling functions. This minimum quantization value 1085 is provided to the shifting processes 1095 to facilitate a shift less than it would have been otherwise, then a corresponding shift in the other direction of the amount less than it would have otherwise been. In this manner, only a single value, namely the minimum quantization value or PERIOD_CALC2(QPmin), is provided typically through a “side channel” process 1090. In this manner, the shifting of the coefficients is by the corresponding values in the quantization matrix, but only a limited amount of data needs to be provided in addition to that stored in memory. In general, the ceiling and/or flooring values may be any set of data less than the entire quantization matrix.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for decoding video comprising:
(a) receiving quantized coefficients representative of a block of video representative of a plurality of pixels;
(b) dequantizing said quantized coefficients;
(c) applying a modification to said dequantized coefficients based upon a quantization matrix;
(d) inverse transforming said dequanized coefficients to determine a decoded residue.

2. The method of claim 1 wherein said dequantizing is based upon a coefficient index, a bit increment, a transform size, and said quantization matrix.

3. The method of claim 1 wherein said modification is based upon a coefficient index, a bit increment, a transform size, and said quantization matrix

4. The method of claim 1 wherein said modification is based upon 2^{(QP/6+B)}, where QP is a quantization matrix, and B relates to a transform size.

5. The method of claim 1 wherein said modified dequantized coefficients are clipped prior to storing in a memory and said clipped coefficients are read from said memory for said inverse transforming.

6. The method of claim 1 wherein said dequantization and said modification of said dequantized coefficients are jointly based upon said quantization matrix.

7. The method of claim 6 wherein said modification is a shift operation.

8. The method of claim 7 wherein said dequantized coefficients are clipped prior to said modification.

9. The method of claim 8 wherein said modification is based upon a single value based upon said quantization matrix.

10. The method of claim 9 wherein said single value is based upon a minimum function.

11. The method of claim 10 further comprising another modification operating on said dequantized coefficients based upon said quantization matrix and the resulting data is subsequently said clipped.

12. The method of claim 1 wherein said dequantized coefficients are further modified as a result of an adjustment mechanism.

13. The method of claim 12 wherein said adjustment mechanism is a variable dependent on transform size.

14. The method of claim 12 wherein said adjustment mechanism is a function of at least one of a received quantization parameter and a transform size.
